(19) United States
(12) Patent Application Publication
(10) Pub. No.: US 2016/0120727 A1
(43) Pub. Date: May 5, 2016

(54) Biodegradable Burial Bag and Methods of Use

(71) Applicant: Randall G. Harreld, Greenville, SC (US)

(72) Inventor: Randall G. Harreld, Greenville, SC (US)

(21) Appl. No.: 14/929,285

(22) Filed: Oct. 31, 2015

Related U.S. Application Data
(60) Provisional application No. 62/073,595, filed on Oct. 31, 2014.

(51) Int. Cl. A61G 17/06; B29D 22/00; B65D 33/24; A61G 17/007; B65D 33/25

(52) U.S. Cl. CPC A61G 17/06; A61G 17/007; B65D 33/25; B65D 33/24; B29D 22/003; B29K 2029/04

(57) ABSTRACT

Compostable and incinerable burial bags and liners and methods of manufacture and use are provided.

### CROSS-REFERENCE TO RELATED APPLICATIONS

This utility patent application claims benefit of U.S. Provisional Patent Application Ser. No. 62/073,595, filed in the United States Patent and Trademark Office on Oct. 31, 2014, which is incorporated herein by reference in its entirety.

### BACKGROUND

Numerous ways are known of preparing cadavers for burial or final disposition. These range from coffins to cremation. However, for those who wish to bury their loved ones with minimal impact on the environment while using fewer resources, or for those who need to reduce costs, burial options have not changed greatly in hundreds of years and options are limited. For those who choose cremation, the need to reduce costs and concerns about residue are still significant considerations.

Currently most natural or “green” burials are accomplished with great risk of bodily fluid and/or embalming liquid drainage or leakage because bodies are placed into wooden caskets or natural fibrous wrappings (e.g., cotton or wool blankets) with no liner. Without a plastic liner, for instance, the structural integrity of a biodegradable casket may be compromised by leaking fluids and/or ruined aesthetics may occur (such as discoloration of the casket). This is particularly troublesome for some religious practices that require the use of shredded newspaper or other natural materials to absorb fluids. Still other burial practices often include the use of common plastic body bags, heavy duty disaster pouches, coroner bags, common trash bags or other non-degradable polymer liners. Not only do such bags increase costs, they are not bio-friendly. In the case of a biodegradable casket made, for instance, from waffle cardboard, the use of non-biodegradable liners or bags defeats the purpose of a green burial since such bags will remain long after the body and casket have decomposed.

What is needed in the burial and cremation industries is an all-natural method of burying or disposal of the deceased that leaves little to no trace over a brief time, or in the event of a conventional casket and burial, a means of providing improved identification of the deceased and temporarily containing decomposition residue until burial.

### BRIEF SUMMARY OF THE DISCLOSURE

The present disclosure generally provides systems for burying or cremating the deceased using biodegradable, decomposable, compostable, or “green” burial bags, containers and liners, and methods of making these earth-friendly products.

According to one embodiment of the disclosure, a compostable burial system may include a compostable body bag having a first layer made of polylactic acid, a second layer made of polylactic acid and polyvinyl alcohol, a third layer made of polylactic acid, a fourth layer may be second layer made of polylactic acid and polyvinyl alcohol, and a fifth layer made of polylactic acid. At least one of the layers may include starch. The compostable body bag may have a pocket for receiving a cadaver and means to close the cadaver within the pocket such as a zipper or a flap, which can prevent fluid leakage like bodily fluids or embalming fluids. The compostable body bag biodegrades between about fifty days to about seventy days, preferably about sixty days, and leaves no residue.

In an exemplary aspect of the disclosure, a method of manufacturing the compostable burial system may include extruding or molding the layers, forming the body bag from the layers; and forming the means to close with the body bag.

In another aspect, a decomposable burial bag may include a compartment having a plurality of biodegradable layers of film made of polylactic acid, polyvinyl alcohol, starch, and combinations of these materials. The compartment can receive a cadaver and the compartment can be closed with means for closing such as zippers, hook and loop fasteners such as Velcro® fasteners, flaps, snaps and the like.

In one example, the compartment and the means for closing may have a melting temperature in the range of about 145° C. to about 160° C. The compartment can decompose within about fifty days to about seventy days, preferably about sixty days, leaving no residue.

In yet another embodiment, a biodegradable burial liner may have a plurality of layers of thin film made from polylactic acid, polyvinyl alcohol, starch, and combinations thereof, and the layers of film can be cut and configured for insertion in a coffin or casket or other container to render the coffin insoluble from about forty-eight hours to about seven days.

A method of manufacturing compostable, biodegradable, burnable burial bags and liners may include extruding thin film layers through a die; cutting the extruded layers to form a liner or bag; and inserting the liner in a casket.

Additional aspects of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of such variations upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a perspective view of various burial bag embodiments according to the present disclosure;

FIG. 2 is a perspective view of a burial bag embodiment according to an aspect of the disclosure;

FIG. 3 is a detailed perspective view of an aspect of the burial bag embodiment as in FIG. 2;

FIG. 4 is a perspective view of another burial bag embodiment according to a further aspect of the disclosure;

FIG. 5 is a detailed perspective view of an aspect of the burial bag embodiment as in FIG. 4;

FIG. 6 is a magnified view of an exploded cross section of the burial bag as in FIG. 5; and

FIG. 7 is a view of a process according to another embodiment of the disclosure.

### DETAILED DESCRIPTION OF VARIOUS EMBODIMENTS OF THE DISCLOSURE

Detailed reference will now be made to the drawings in which examples embodying the present subject matter are shown. The detailed description uses numerical and letter designations to refer to features of the drawings.

The drawings and detailed description provide a full and written description of the present subject matter, and of the manner and process of making and using various exemplary embodiments, so as to enable one skilled in the pertinent art to make and use them, as well as the best mode of carrying out the exemplary embodiments. However, the examples set forth in the drawings and detailed descriptions are provided by way of explanation only and are not meant as limitations of the disclosure. The present subject matter thus includes any modifications and variations of the following examples as come within the scope of the appended claims and their equivalents.

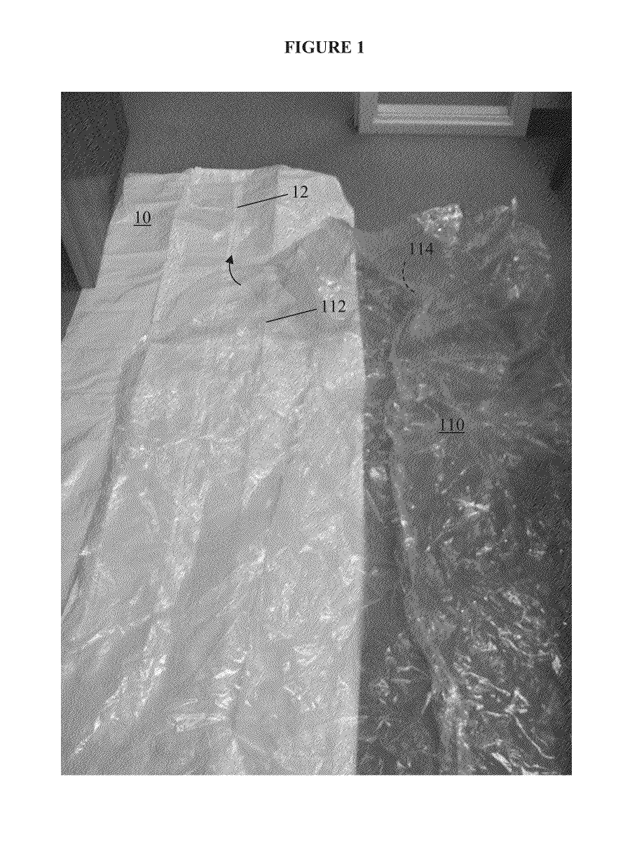

According to an aspect of the present disclosure, GreenBag™ biodegradable body or burial bags are provided for multi-industry use, such as the examples shown in FIGS. 1 through 6. The various exemplary embodiments may use a water soluble polymer film such a polyvinyl alcohol (PVLA or PVOH) film approximately 1-5 MIL, more particularly about 3 MIL, in thickness. Such film may have an acetic acid odor and be clear or translucent for viewing purposes, or made opaque. Its melting point is between 160° C. to about 220° C. with thermal decomposition occurring at approximately 300° C. The film is soluble in hot water but stable under normal ambient conditions of temperature and pressure. An exemplary film for use in various embodiments of the present disclosure is available from the Monosol Company of Indiana under the brand MONOSOL M 1030; or from FKuR of Germany under the brand Bio-Flex® F 2110 W, produced in Yorkshire, England. However, the disclosure is not limited thereto; other films may be utilized.

With particular reference to FIG. 1, a biodegradable or compostable burial bag or container is designated in general by the reference number 10. The compostable burial bag 10 may include a zipper system 12 and may be opaque or a dark or solid color to prevent viewing a body therein. Another embodiment is broadly designated 110 and is shown next to bag 10 for comparison. Here, the compostable container 110 may be clear and may utilize a flap 112 and a compartment, envelope or pocket 114 to hold or contain a body. As shown by the curved arrow, once a body is in the pocket 114, the flap 112 may be folded over to close the body within the pocket 114. The flap or fold method used with compostable bag 110 may be particularly useful with deceased persons of varying sizes, i.e., one size fits all, and is therefore useful in several key industries in deceased body care.

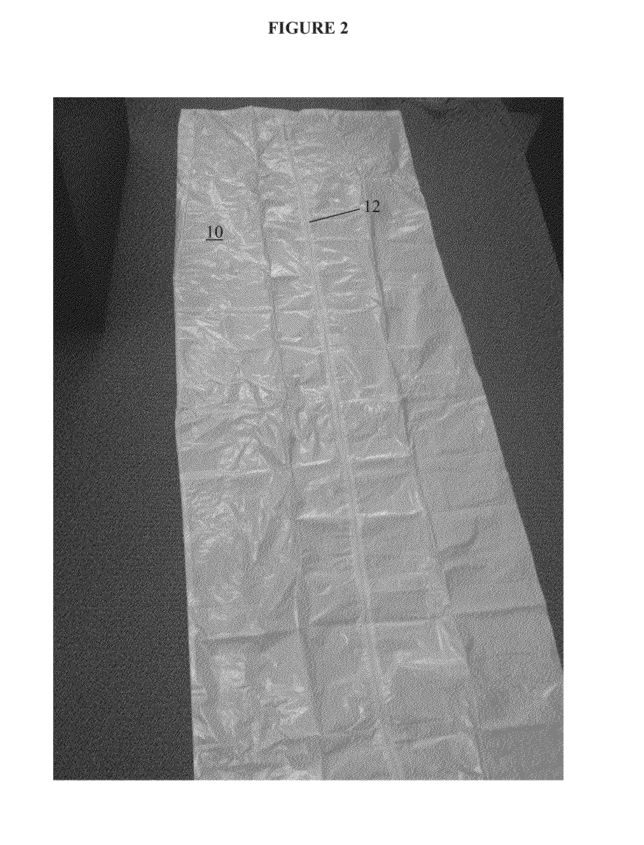

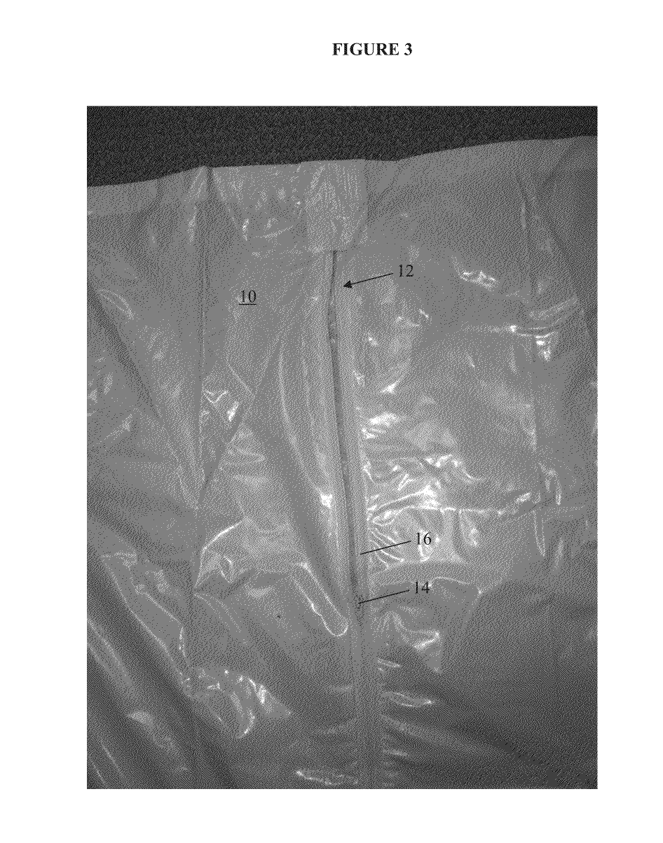

The center-zipper embodiment 10, as most clearly shown in FIGS. 2 and 3, has been tested in body removal such as in the medical industry and in the funeral/cremation industry. The material is sufficiently strong that it resists tearing or ripping during manipulation and under heavy strain (e.g., pulling on the bag and moving from multiple surfaces). Here, a zipper 14 and tracks 16 of the zipper system 12 may be made of compostable or burnable material. Those skilled in the art will understand that snaps, flaps, and other closure means may be used in addition or as alternatives to the zipper system 12. Based on its unique material composition, there is no residue from the bag 10 when the cremation or composting is complete.

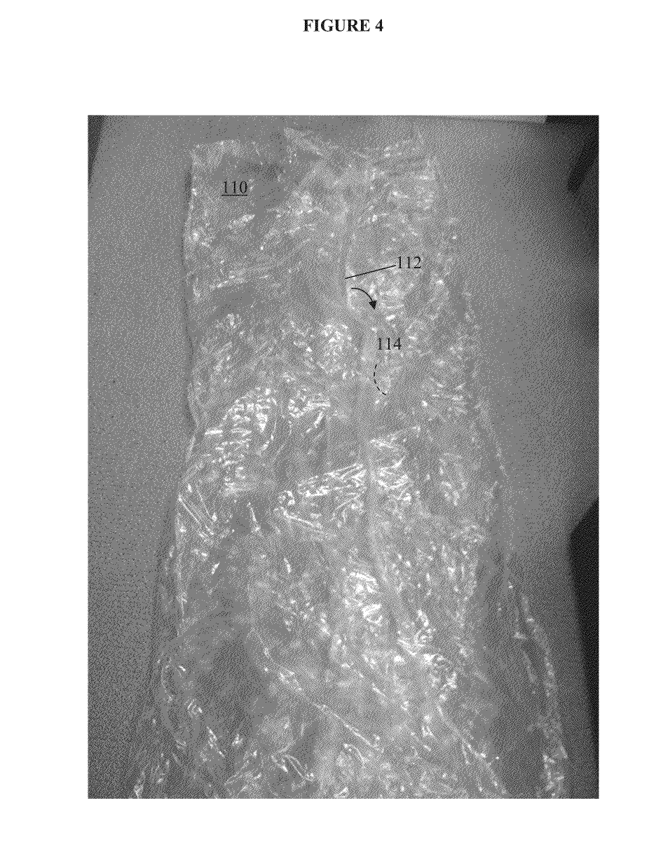

According to a further aspect of the present disclosure, a GreenBag™ burial bag available from the present inventor and as shown in FIG. 3 is completely degradable or compostable and follows a human body's natural decomposition timetable, which is approximately two months. However, the GreenBag™ burial bag will commence to break down or begin to decompose within days following burial. Nevertheless, the GreenBag™ burial bag shown in FIGS. 3 and 4 will remain intact during the time of pre-burial body storage and traditional funeral rites.

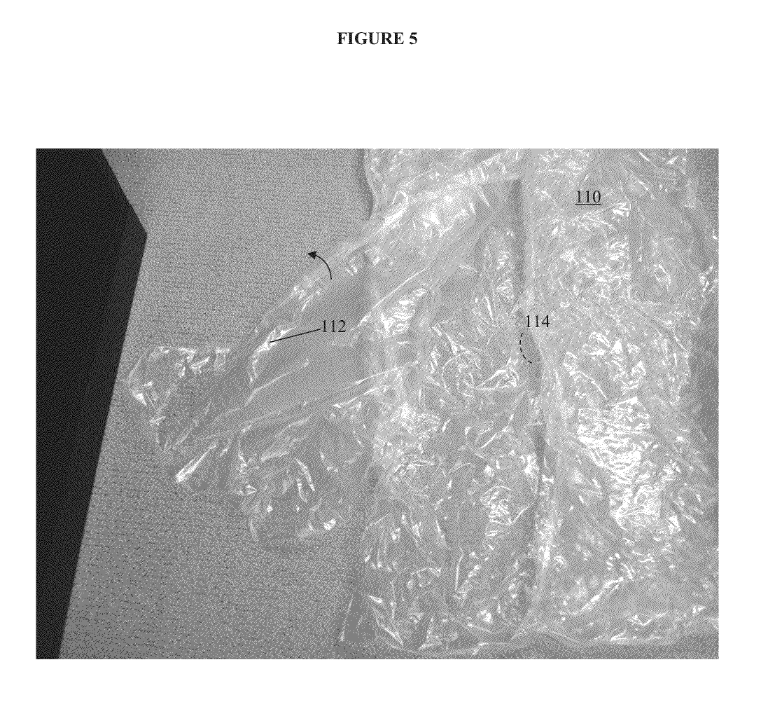

The double-fold or fold-over embodiment 110 is most clearly shown in FIGS. 4 and 5 and is particularly useful in natural burials. As shown in FIG. 4, according to the curved arrow, the flap 112 is folded over to close a body within the pocket 114. In FIG. 5, according to the curved arrow, the flap 112 is opened to reveal the pocket 114. This exemplary embodiment and others may use a the material 118 the following mechanical properties shown in Table 1:

TABLE 1

| | |
|---|---|
| Tensile modulus of elasticity | 800 MPa |
| Tensile strength | 21 MPa |
| Tensile strain at tensile strength | 350% |
| Tensile stress at break | 18 MPa |
| Tensile strain at break | 360% |
| Flexural modulus | 690 MPa |
| Flexural strain at break | no break % |
| Flexural stress at 3.5% strain | 17 MPa |
| Notched impact strength (Charpy), RT | 37 kJ/m² |
| Impact strength (Charpy), RT | no break kJ/m² |
| Density | 1.27 g/cm³ |
| Bulk density | n/a kg/m³ |

The exemplary embodiment and others may have the following thermal properties as shown in Table 2:

TABLE 2

| | |
|---|---|
| Melt temperature | 145-160° C. |
| Vicat A softening temperature | 81° C. |
| Heat distortion temperature HDT B | n/a [° C.] |
| Melt volume rate (190° C./2.16 kg) | 2.5-4.0 cm³/10 min |
| Melt flow rate (190° C./2.16 kg) | 2.0-3.5 g/10 min |

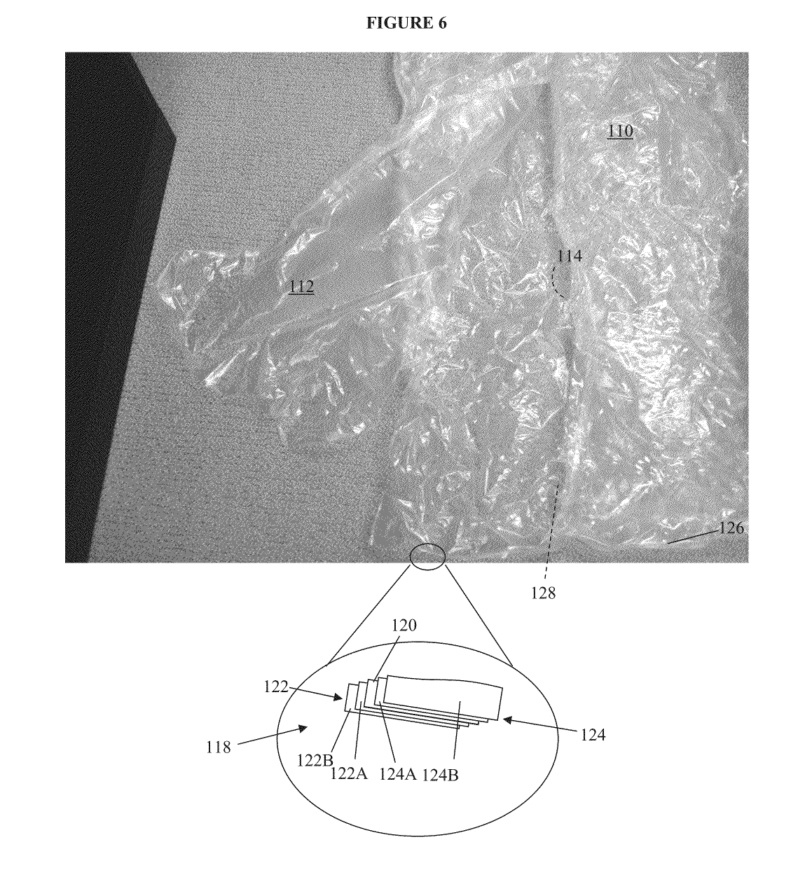

Turning to FIG. 6, the container 110 is shown with the flap 112 open and the pocket or cavity 114 exposed. Shown here are seamed ends 126 and a longitudinal opening 128 into the pocket 114 for insertion of a body. The material 118 used for the container 110 may have a core or middle section or layer 120 made from polyvinyl alcohol (PVOH) sandwiched between two outer or external layers 122, 124, all made from biodegradable polymers. More specifically, the exploded inset view in FIG. 6 shows aspects of the embodiment of FIG. 5 in detail in which the PVOH layer 120 may be fused between the outer, dual layers 122, 124, which are also fused together. In this example, first section 122 may include first and second sublayers 122A, 122B, and second section 124 may include first and second sublayers 124A, 124B. More specifically, a first layer may be polylactic acid (PLA), a second layer may be PLA+PVOH+starch, the third or middle layer may be PVOH, the fourth layer may be PLA+PVOH and/or starch and the fifth layer may be PLA.

As introduced above, the decomposition or composting process begins with a breakdown of the outer layers 122, 124 occurring first from natural processes; i.e., biotic decomposition in which breakdown of materials is caused by insects, microorganisms and the like. Then, heat degradation of the core layer 120 results from cadaver fluids and/or moisture in the earth surrounding the body in the case of green or natural burial; i.e., abiotic degradation occurring through chemical or physical processes, e.g. hydrolysis.

The embodiments herein may be produced by extrusion or blow molding then fusing, seaming, and cutting to produce multiple layer biodegradable body bags such as the exemplary 5-layer bag 110 in FIG. 6. Those skilled in the art will appreciate that fewer layers of biodegradable material having increased or varying thicknesses, or additional layers, may be utilized. Thus, the disclosure is not limited to the exemplary 5-layer biodegradable pouch shown in FIG. 6.

As further shown in FIG. 6, the GreenBag™ burial bag may be formed with opaque film for situations in which it is neither necessary nor desirable to view the deceased through the bag 110. However, as introduced in FIG. 1 in accordance with another aspect of the disclosure, the material used in the GreenBag™ burial bag may be substantially clear so that users may visually and quickly identify bodies. This may be helpful in medical situations (e.g., morgue use) and for identification in funeral home settings.

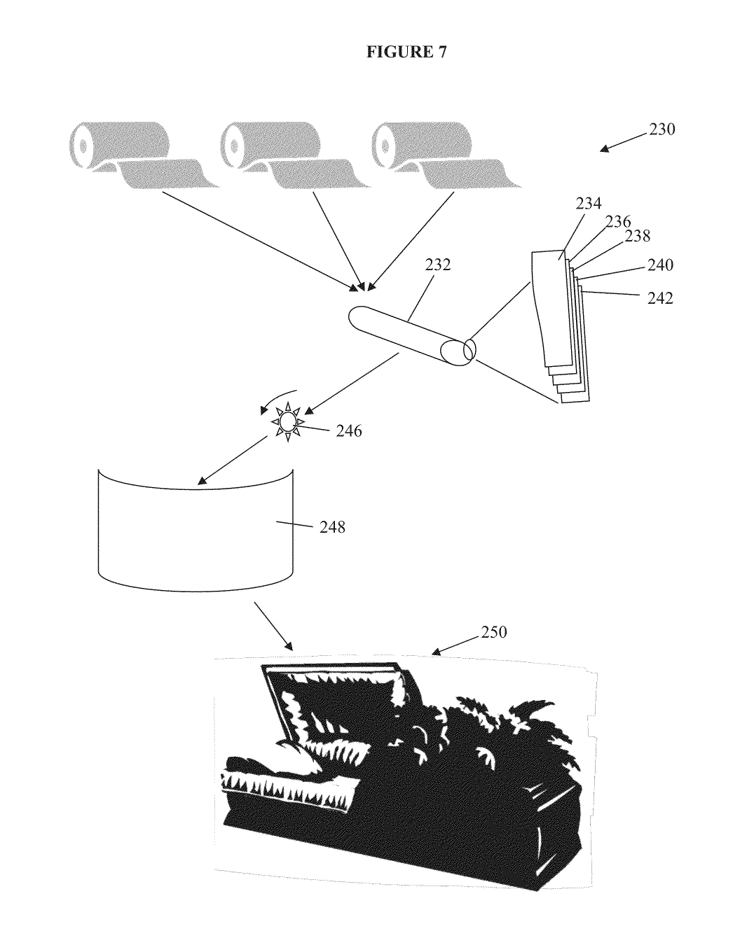

Turning to FIG. 7, a process 230 of manufacturing and using a BIOLINE™ liner 232 is shown. The BIOLINE™ liner, like the GreenBag™ burial bag, is available from the present inventor and may have multiple layers for strength and temporary insolubility. For instance, a first layer 234 may be polylactic acid (PLA), a second layer 236 may be PLA+PVOH+starch, a third or middle layer 238 may be PVOH, a fourth layer 240 may be PLA+PVOH and/or starch and a fifth layer 242 may be PLA. As shown, the BIOLINE™ liner may be extruded through a multi-layer die 246 then cut to form a casket liner 248. The BIOLINE™ liner may be inserted in a casket 250 and a deceased body placed into the casket for viewing and the like. Accordingly, the BIOLINE™ liner withstands leakage of decomposition and embalming fluids for a limited time until burial.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

That which is claimed is:

1. A burial system, comprising:
a body bag having a first layer made of polylactic acid, a second layer made of polylactic acid and polyvinyl alcohol, a third layer made of polylactic acid, a fourth layer made of polylactic acid and polyvinyl alcohol, and a fifth layer made of polylactic acid,
wherein the body bag includes a pocket therein for receiving a cadaver and means to close the cadaver within the pocket, the means to close being configured to prevent fluid leakage, and
wherein the body bag is incinerable or compostable.

2. The burial system as in claim 1, wherein at least one of the layers includes starch.

3. The burial system as in claim 1, wherein the means to close is one of a zipper and a flap.

4. The burial system as in claim 1, wherein the body bag biodegrades within about fifty days to about seventy days, preferably about sixty days, leaving no residue.

5. A decomposable burial bag, comprising:
a compartment having a plurality of biodegradable layers of film selected from the group consisting of polylactic acid, polyvinyl alcohol, starch, and combinations thereof, the compartment being configured to receive a cadaver therein; and
means for closing the compartment.

6. The decomposable burial bag as in claim 5, wherein the compartment and the means for closing have a melting temperature in the range of about 145° C. to about 160° C.

7. The decomposable burial bag as in claim 5, wherein the compartment decomposes between about fifty days to about seventy days, preferably about sixty days, leaving no residue.

8. The decomposable burial bag as in claim 5, wherein the means to close is one of a zipper and a flap.

9. A biodegradable burial liner, comprising:
a plurality of layers of film selected from the group consisting of polylactic acid, polyvinyl alcohol, starch, and combinations thereof, and
wherein the layers of film are configured for insertion in a coffin to render the coffin insoluble from about forty-eight hours to about seven days.

10. A method of manufacturing the biodegradable burial liner as in claim 9, comprising:
extruding the layers through a die;
cutting the extruded layers to form a liner; and
inserting the liner in a casket.

11. A method of manufacturing the burial system as in claim 1, comprising:
extruding the layers through a die;
forming the body bag from the extruded layers; and
forming the means to close with the body bag.

12. A method of using the burial system as in claim 1, comprising:
placing the cadaver in the pocket;
burying the body bag with the cadaver in the pocket;
decomposing the first and fifth layers through biotic processes;
decomposing the third layer through abiotic processes; and
completing decomposition of the body bag and the cadaver.
